(19) United States
(12) Patent Application Publication
(10) Pub. No.: US 2025/0301021 A1
(43) Pub. Date: Sep. 25, 2025

(54) METHOD, APPARATUS, SYSTEM, AND COMPUTER PROGRAM FOR ACCOUNT ANALYSIS AND MANAGEMENT

(71) Applicant: SAMSUNG SDS CO., LTD., Seoul (KR)

(72) Inventors: Dongho KIM, Seoul (KR); Hongchul LEE, Seoul (KR); Siwan BAE, Seoul (KR)

(73) Assignee: SAMSUNG SDS CO., LTD., Seoul (KR)

(21) Appl. No.: 19/087,774

(22) Filed: Mar. 24, 2025

(30) Foreign Application Priority Data
Mar. 25, 2024 (KR) 10-2024-0040586
May 29, 2024 (KR) 10-2024-0069868

(51) Int. Cl. H04L 9/40

(52) U.S. Cl. CPC H04L 63/20; H04L 63/104

(57) ABSTRACT

A processor-implemented method including generating a risk analysis on respective accounts of one or more accounts, the one or more accounts being linked to each service of one or more services, generating an integrated risk analysis on a first account, among the one or more accounts, by considering both of a first risk analysis result for a first service and a second risk analysis result for a second service, among the one or more services, and presenting an account management recommendation for the first account responsive to a result of the integrated risk analysis.

### CROSS-REFERENCE TO RELATED APPLICATION(S)

This application claims the benefit under 35 U.S.C. § 119 to Korean Patent Application No. 10-2024-0040586, filed on Mar. 25, 2024, and Korean Patent Application No. 10-2024-0069868, filed on May 29, 2024 in the Korean Intellectual Property Office, the entire disclosure of which is incorporated herein by reference for all purposes.

### BACKGROUND OF THE INVENTION

### 1. Field of the invention

The disclosure relates to a method, device, system, and computer program for analyzing and managing accounts and, more specifically, to a method, device, system, and computer program for analyzing accounts linked to one or more services and managing efficiently the same.

### 2. Description of the Related Art

In recent years, with the increase in security-related issues, interest in account management has also been continuously growing in companies.

More specifically, account managers in companies manage accounts by giving accounts to users or user groups and granting authority for one or more services to each account.

However, account management may be slack when users change departments or leave the company, and even when tasks change after granting authority for one or more services to perform the given tasks, the granted authority may often be carelessly managed, which may give attackers ammunition for hijacking the unused accounts, thereby increasing security risks.

Furthermore, even when account managers wish to perform account management by recognizing and analyzing the status of users or user groups linked to the respective service, practical limitations exist that require a huge amount of time and resources for account managers to directly perform the aforementioned account management due to the increasing number of users and scale of services.

In addition, even though the accounts are managed for each section by placing a firewall in terms of zero trust, which has been attracting attention recently, if the management of accounts is not accurately performed, it may be difficult to secure security for each firewall section.

Accordingly, a method is required to analyze accounts for users or user groups, provide the authority required for each account, and identify and manage unnecessary accounts or authority, thereby suppressing account hijacking by attackers and blocking security threats, but no appropriate solution has been presented yet.

### SUMMARY OF THE INVENTION

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In a general aspect, here is provided a processor-implemented method including generating a risk analysis on respective accounts of one or more accounts, the one or more accounts being linked to each service of one or more services, generating an integrated risk analysis on a first account, among the one or more accounts, by considering both of a first risk analysis result for a first service and a second risk analysis result for a second service, among the one or more services, and presenting an account management recommendation for the first account responsive to a result of the integrated risk analysis.

The generating the risk analysis may include identifying each account having access authority for each of the one or more services, retrieving information about access history for each account, and executing a risk analysis on each account according to a predetermined criterion.

The generating the risk analysis further may include determining a presence of a risk by identifying whether a predetermined service access period has been exceeded on a basis of an access history of each account.

The generating the risk analysis may include determining the presence of the risk by considering an access location of each account.

The generating the risk analysis further may include generating a first list, the first list including risk analysis results for the respective accounts linked to each service of the one or more services.

The generating the integrated risk analysis may include determining whether to perform a deletion of the first account or a change of authority thereof responsive to the result of the integrated risk analysis.

The generating the integrated risk analysis may include determining whether to create a group account for a plurality of accounts including the first account responsive to the result of the integrated risk analysis.

The generating the integrated risk analysis may include generating a second list, the second list including a result of the integrated risk analysis respectively performed on multiple risk analysis results for the respective accounts.

The presenting the account management recommendation may include determining whether to perform the account management recommendation for the first account responsive to results of the risk analysis and the integrated risk analysis.

In a general aspect, here is provided an apparatus including processors configured to execute instructions, a memory storing the instructions, and execution of the instructions configures the processors to generate a risk analysis on respective accounts of one or more accounts, the one or more accounts being linked to each service of one or more services, generate an integrated risk analysis on a first account, among the one or more accounts, by considering both of a first risk analysis result for a first service and a second risk analysis result for a second service, among the one or more services, and present an account management recommendation for the first account responsive to a result of the integrated risk analysis.

The generating the risk analysis may include identifying each account having access authority for each of the one or more services, retrieving information about access history for each account, and executing a risk analysis on each account according to a predetermined criterion.

The generating the risk analysis may include analyzing whether there is a risk by identifying whether a predetermined service access period has been exceeded, based on the access history of each account.

The generating the risk analysis may include determining a presence of a risk by identifying whether a predetermined service access period has been exceeded on a basis of an access history of each account.

The generating the risk analysis may include generating a first list, the first list including risk analysis results for the respective accounts linked to each service of the one or more services.

The generating the integrated risk analysis may include determining whether to delete the first account or change an authority thereof responsive to the result of the integrated risk analysis.

The generating the integrated risk analysis may include determining whether to create a group account for a plurality of accounts including the first account responsive to the result of the integrated risk analysis.

The generating the integrated risk analysis may include generating a second list, the second list including a result of integrated risk analysis executed based on multiple risk analysis results for the respective accounts.

The presenting the account management recommendation may include determining whether to perform the account management recommendation for the first account responsive to results of the risk analysis and the integrated risk analysis.

In a general aspect, here is provided a computer-readable storage medium storing instructions configured to, when executed by a processor, cause an apparatus, including the processor and analyzing one or more accounts linked to one or more services, to implement specific operations, including generate a risk analysis on respective accounts of one or more accounts, the one or more accounts being linked to each service of one or more services, generate an integrated risk analysis on a first account, among the one or more accounts, by considering both of a first risk analysis result for a first service and a second risk analysis result for a second service, among the one or more services, and perform an account management recommendation for the first account responsive to a result of the integrated risk analysis.

The generating the risk analysis may include identifying each account having access authority for each of the one or more services, retrieving information about access history for each account, and executing a risk analysis on each account according to a predetermined criterion.

### BRIEF DESCRIPTION OF THE DRAWINGS

FIG. 1 is a diagram illustrating the configuration of an account analysis management system according to an embodiment of the disclosure.

FIG. 2 is a flowchart illustrating an account analysis management method according to an embodiment of the disclosure.

FIG. 3 is a diagram illustrating a specific configuration and operation of an account analysis management system according to an embodiment of the disclosure.

FIG. 4 is a diagram illustrating a specific flowchart of steps performed in an account analysis management method according to an embodiment of the disclosure.

FIG. 5 is a block diagram illustrating the configuration of an account analysis management apparatus according to an embodiment of the disclosure.

FIG. 6 is a diagram illustrating a specific configuration and operation of an account analysis management system according to an embodiment of the disclosure.

FIG. 7 is a flowchart illustrating a specific operation in an account analysis management system according to an embodiment of the disclosure.

FIG. 8 is a diagram illustrating the configuration of a computing device according to an embodiment of the disclosure.

Throughout the drawings and the detailed description, unless otherwise described or provided, the same, or like, drawing reference numerals may be understood to refer to the same, or like, elements, features, and structures. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences within and/or of operations described herein are merely examples, and are not limited to those set forth herein, but may be changed as will be apparent after an understanding of the disclosure of this application, except for sequences within and/or of operations necessarily occurring in a certain order. As another example, the sequences of and/or within operations may be performed in parallel, except for at least a portion of sequences of and/or within operations necessarily occurring in an order, e.g., a certain order. Also, descriptions of features that are known after an understanding of the disclosure of this application may be omitted for increased clarity and conciseness.

The features described herein may be embodied in different forms, and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application.

Throughout the specification, when a component or element is described as being “on”, “connected to,” “coupled to,” or “joined to” another component, element, or layer it may be directly (e.g., in contact with the other component or element) “on”, “connected to,” “coupled to,” or “joined to” the other component, element, or layer or there may reasonably be one or more other components, elements, layers intervening therebetween. When a component or element is described as being “directly on”, “directly connected to,” “directly coupled to,” or “directly joined” to another component or element, there can be no other elements intervening therebetween. Likewise, expressions, for example, “between” and “immediately between” and “adjacent to” and “immediately adjacent to” may also be construed as described in the foregoing.

As used in connection with various example embodiments of the disclosure, any use of the terms “module” or “unit” means hardware and/or processing hardware configured to implement processor or computer executable instructions (e.g., as code segment(s), program(s), and/or firmware) to configure such processing hardware to perform corresponding operations, and may interchangeably be used with other terms, for example, “logic,” “logic block,” “part,” or “circuitry”. As one non-limiting example, an application-predetermined integrated circuit (ASIC) may be referred to as an application-predetermined integrated module. As another non-limiting example, a field-programmable gate array (FPGA) or an application-specific integrated circuit (ASIC) may be respectively referred to as a field-programmable gate unit or an application-specific integrated unit. In a non-limiting example, such executable instructions may include components such as program components, object-oriented code or program components, class components, and may include processor task components, processes, functions, attributes, procedures, subroutines, segments of the code or program. Executable instructions may further include programs, drivers, firmware, microcode, circuits, data, database, data structures, tables, arrays, and variables. In another non-limiting example, such executable instructions may be executed by one or more central processing units (CPUs) of an electronic device or secure multimedia card.

Although terms such as “first,” “second,” and “third”, or A, B, (a), (b), and the like may be used herein to describe various members, components, regions, layers, or sections, these members, components, regions, layers, or sections are not to be limited by these terms. Each of these terminologies is not used to define an essence, order, or sequence of corresponding members, components, regions, layers, or sections, for example, but used merely to distinguish the corresponding members, components, regions, layers, or sections from other members, components, regions, layers, or sections. Thus, a first member, component, region, layer, or section referred to in the examples described herein may also be referred to as a second member, component, region, layer, or section without departing from the teachings of the examples.

The terminology used herein is for describing various examples only and is not to be used to limit the disclosure. The articles “a,” “an,” and “the” are intended to include the plural forms as well, unless the context clearly indicates otherwise. As non-limiting examples, terms “comprise” or “comprises,” “include” or “includes,” and “have” or “has” specify the presence of stated features, numbers, operations, members, elements, and/or combinations thereof, but do not preclude the presence or addition of one or more other features, numbers, operations, members, elements, and/or combinations thereof, or the alternate presence of an alternative stated features, numbers, operations, members, elements, and/or combinations thereof. Additionally, while one embodiment may set forth such terms “comprise” or “comprises,” “include” or “includes,” and “have” or “has” specify the presence of stated features, numbers, operations, members, elements, and/or combinations thereof, other embodiments may exist where one or more of the stated features, numbers, operations, members, elements, and/or combinations thereof are not present.

Due to manufacturing techniques and/or tolerances, variations of the shapes shown in the drawings may occur. Thus, the examples described herein are not limited to the specific shapes shown in the drawings, but include changes in shape that occur during manufacturing.

Unless otherwise defined, all terms, including technical and scientific terms, used herein have the same meaning as commonly understood by one of ordinary skill in the art to which this disclosure pertains and based on an understanding of the disclosure of the present application. Terms, such as those defined in commonly used dictionaries, are to be interpreted as having a meaning that is consistent with their meaning in the context of the relevant art and the disclosure of the present application and are not to be interpreted in an idealized or overly formal sense unless expressly so defined herein. The use of the term “may” herein with respect to an example or embodiment, e.g., as to what an example or embodiment may include or implement, means that at least one example or embodiment exists where such a feature is included or implemented, while all examples are not limited thereto.

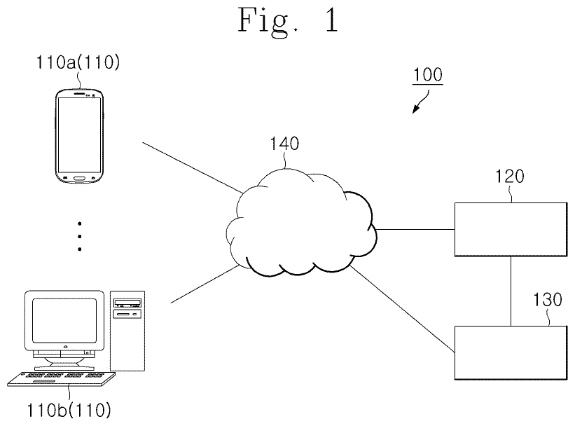

First, FIG. 1 is a diagram illustrating the configuration and operation of an account analysis management system 100 according to an embodiment of the disclosure. As shown in FIG. 1, the account analysis management system 100 according to an embodiment of the disclosure may be configured to include one or more user terminals 110a and 110b, an account management target system 130 that operates one or more services in which users are assign accounts and access the same to perform tasks, and an account analysis management apparatus 120 that performs account analysis and management for services operated by the account management target system 130.

In this case, various terminals such as personal computers (PCs), laptop PCs, tablet PCs, smartphones, and PDAs may be used as the terminals 110a and 110b, but the disclosure is not necessarily limited thereto, and in addition, various devices that are linked with the user's device to provide the account management target system 130 with information necessary for the user to perform tasks using one or more services or that are able to provide an environment in which the account manager of the account management target system 130 may perform analysis and management on the user's account and the like may be used as the terminals 110a and 110b.

In addition, the account analysis management apparatus 120 may be implemented as a system capable of perform account analysis and management on one or more services using one or more physical servers, but the disclosure is not necessarily limited thereto, and it may be configured using personal computer processing devices such as desktop computers, laptops, tablets, and smartphones, configured based on a cloud system, or implemented in various forms such as dedicated devices, in addition to the above.

In addition, the account management target system 130 may be implemented as a system capable of operating one or more services or the like using one or more physical servers or performing account management such as creating, changing, and deleting accounts for one or more services, but the disclosure is not necessarily limited thereto, and it may be configured using personal computer processing devices such as desktop computers, laptops, tablets, and smartphones, configured based on a cloud system, or implemented in various forms such as dedicated devices, in addition to the above.

In addition, the terminals 110a and 110b and the account analysis management apparatus 120 may be implemented to be integrated into one server or device.

In addition, a wired network and a wireless network may be used as a network 140 connecting the terminals 110a and 110b, the account analysis management apparatus 120, and the account management target system 130 in FIG. 1, and specifically, various communication networks such as a local area network (LAN), a metropolitan area network (MAN), and a wide area network (WAN) may be included. In addition, the network 140 may include the well-known World Wide Web (WWW). In addition, the network 140 may also be implemented using a data bus configured to transmit and receive data.

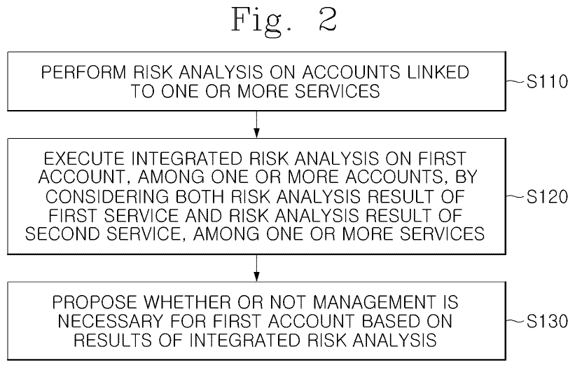

In addition, FIG. 2 illustrates a flowchart of an account analysis management method according to an embodiment of the disclosure.

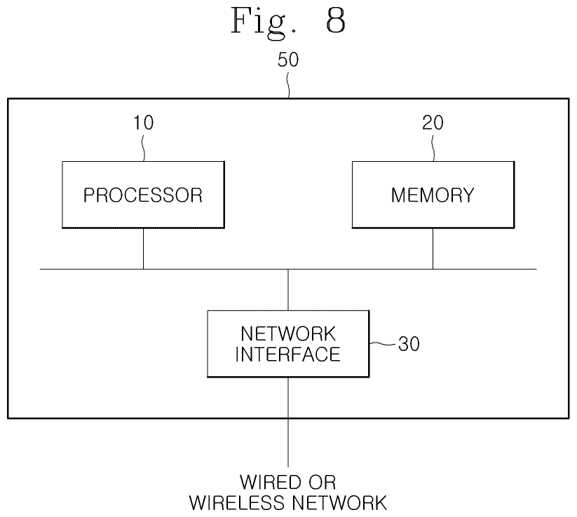

Here, the method illustrated in FIG. 2 may be performed by, for example, the account analysis management apparatus 120, and further, the account analysis management apparatus 120 may be implemented to include a computing device 50 in FIG. 8 and the description made below with reference to FIG. 8. For example, the account analysis management apparatus 120 may be equipped with a processor 10, and the processor 10 may execute instructions configured to implement an operation for performing account analysis and management.

More specifically, as shown in FIG. 2, the account analysis management method according to an embodiment of the disclosure is a method for performing analysis on one or more accounts linked to one or more services using a computing device 50 such as the account analysis management apparatus 120, and may include a step S110 of performing risk analysis on each of the accounts linked to one or more services, a step S120 of executing integrated risk analysis on a first account, among one or more accounts, by considering both a risk analysis result of a first service and a risk analysis result of a second service, among one or more services, and a step S130 of proposing whether or not management is necessary for the first account, based on the results of the integrated risk analysis.

Here, the step S110 of performing risk analysis may include a step S111 of producing each account having access authority for each of one or more services, a step S112 of producing information about access history for each account, and a step S113 of executing risk analysis on each account according to predetermined criteria.

In addition, in the step S110 of performing risk analysis, it may be analyzed whether there is a risk by identifying whether a predetermined service access period has been exceeded, based on the access history of each account.

In addition, in the step S110 of performing risk analysis, it may be analyzed whether there is a risk by also considering an access location of each account.

In addition, in the step S110 of performing risk analysis, a first list may be generated to include risk analysis results for the respective accounts linked to each of the one or more services.

In addition, in the step S120 of executing integrated risk analysis, it may be determined whether deletion of the first account or change of authority thereof is necessary.

In addition, in the step S120 of executing integrated risk analysis, it may be determined whether creation of a group account is necessary for a plurality of accounts including the first account.

In addition, in the step S120 of executing integrated risk analysis, a second list may be generated to include a result of integrated risk analysis executed based on multiple risk analysis results for the respective accounts.

In addition, in the step S130 of proposing, it may be proposed whether management is necessary for the first account by considering results of the risk analysis and the integrated risk analysis.

Accordingly, an account analysis and management method, device, system, and computer program according to an embodiment of the disclosure may analyze accounts for users or user groups to provide the authority required for each account, identify and manage unnecessary accounts or authority, block security threats by suppressing an attacker from hijacking the accounts through account management, and enable integrated management of a linked key management system (KMS) or the like through account analysis.

Hereinafter, the configuration and operation of the account analysis and management method, device, and system 100 according to an embodiment of the disclosure will be described in more detail with reference to the drawings.

First, in step S110, the computing device 50 such as the account analysis management apparatus 120 performs risk analysis on respective accounts linked to one or more services.

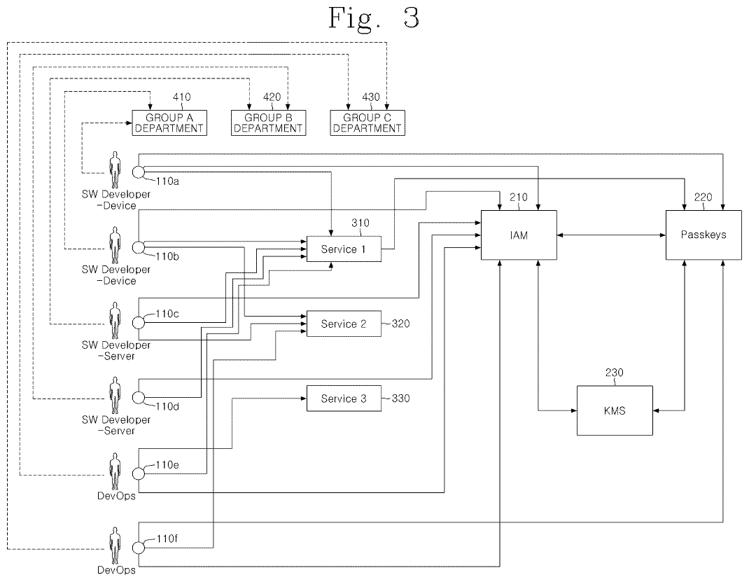

As a more specific example, as shown in FIG. 3, various users such as device software developers, server software developers, and development operators may access service 1 (310), service 2 (320), and service 3 (330) through terminals 110a to 110f and perform tasks such as projects to which they belong.

In this case, the users may perform tasks while belonging to group A 410, group B 420, and group C 430 depending on the task or as an individual user without belonging to any group. In addition, a group account may be created separately from personal accounts for each group and authority may be granted to each group to perform tasks.

In this case, each user may perform authentication for the account through an identity and access management (IAM) system 210, and accordingly, the identity and access management (IAM) system 210 may retain information about the user's access history to the respective services and provide this information upon request by the user or administrator.

In addition, the services 310, 320, and 330 may include a development environment, database, and various other work-related services or systems that users may use to perform tasks.

Accordingly, in step S110, the account analysis management apparatus 120 may perform risk analysis on the respective accounts linked to one or more services (e.g., 310, 320, and 330).

In this case, the account analysis management apparatus 120 may perform risk analysis based on machine learning (ML) techniques or the like in step S110, but the disclosure is not necessarily limited thereto.

As a more specific example, in FIG. 3, the accounts of user 1 of terminal 1 (110a), user 2 of terminal 2 (110b), user 3 of terminal 3 (110c), user 4 of terminal 4 (110d), and user 5 of terminal 5 (110e) are linked to service 1 (310), so risk analysis may be performed on the accounts of user 1 to user 5 for service 1 (310).

In addition, in FIG. 3, the accounts of user 2, user 3 of terminal 3 (110c), and user 5 of terminal 5 (110e) are linked to service 2 (320), so risk analysis may be performed on the accounts of user 2, user 3, and user 5 for service 2 (320).

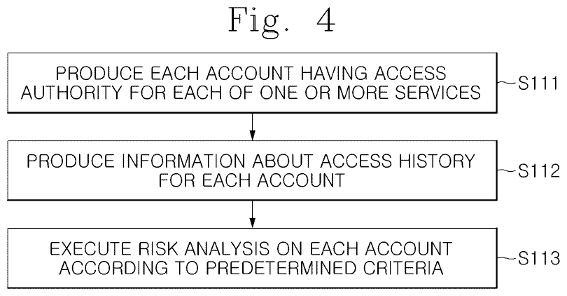

More specifically, as shown in FIG. 4, the step S110 may include a step S111 of producing each accounts having access authority for each of one or more services, a step S112 of producing information about access history for each account, and a step S113 of executing risk analysis for each account according to predetermined criteria.

Accordingly, first, in step S111, the account analysis management apparatus 120 may produce each account having access authority for each of one or more services.

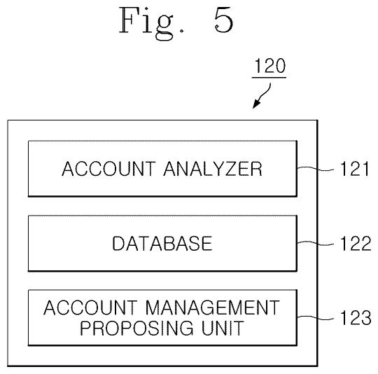

In this case, as shown in FIG. 5, the account analysis management apparatus 120 may be configured to include an account analyzer 121, a database 122, and an account management proposing unit 123.

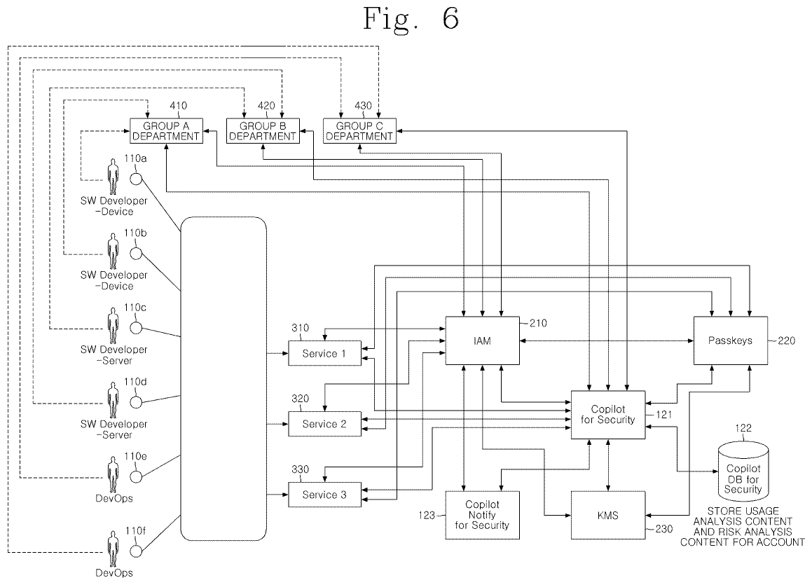

Accordingly, referring to FIG. 6, in step S111, the account analyzer 121 of the account analysis management apparatus 120 may enquire of the server of service 1 (310) or the like to produce the accounts of user 1 to user 5 who have access authority for the service 1 (310), and may also inquire of the server of service 2 (320) or the like to produce the accounts of user 2, user 3, and user 5 who have access authority for the service 2 (320).

In addition, FIG. 6 illustrates the connection relationships between the terminal 110a to 110f and the services 310 to 330 as a box (A in FIG. 6), instead of illustrating specific indications, which indicates that the account manager may perform account management without directly identifying the respective connection relationships in the disclosure.

In this case, the account analyzer 121 may be implemented in the form of a copilot, thereby providing an environment in which users such as account managers may perform analysis and management on multiple accounts and further strengthen security, but this is one embodiment of the disclosure, and the disclosure is not necessarily limited thereto.

Next, in step S112, the account analysis management apparatus 120 may produce information about access history for each account.

More specifically, in FIG. 6, the account analyzer 121 of the account analysis management apparatus 120 may produce access history information for each account through the identity and access management (IAM) system 210 or the like.

As a more specific example, referring to FIG. 6, the account analyzer 121 may enquire of the identity and access management (IAM) system 210 to produce access history information of the accounts of user 1 to user 5 who accessed service 1 (310), and also produce access history information of the accounts of user 2, user 3, and user 5 who accessed service 2 (320).

Next, in step S113, the account analysis management apparatus 120 may execute risk analysis on the respective accounts according to predetermined criteria.

More specifically, the account analysis management apparatus 120 may analyze whether there is a risk by identifying whether each account exceeds a predetermined service access period, based on the access history of the account.

At this time, the account analysis management apparatus 120 may also analyze whether there is a risk by also considering the access location of each account.

In addition, the account analysis management apparatus 120 may generate a first list including risk analysis results for the respective accounts linked to one or more services.

As a more specific example, the account analyzer 121 of the account analysis management apparatus 120 may collect information about group accounts or personal user accounts that have exceeded a predetermined service access period (e.g., 1 month or the like) for each service, determine that there is a risk, and store the same in a database 122.

In addition, the account analyzer 121 may collect information about personal user accounts that have exceeded a predetermined service access period (e.g., 1 month or the like), among the users belonging to a group account that has not exceeded a predetermined service access period (e.g., 1 month or the like) for each service, determine that there is a risk, and store the same in the database 122.

In addition, the account analyzer 121 may determine whether there is a risk by considering the access location of each account (for example, the case where an account, which was accessed from Seoul as the access location for a certain period of time, is recognized to be accessed from China) and store the same in the database 122.

In addition, the account analyzer 121 may generate a first list including risk analysis results for the respective accounts linked to the services.

As a more specific example, the account analyzer 121 may generate a first list including risk analysis results for users 1 to 5 linked to the first service (310) (e.g., a risk analysis result list for accounts based on service 1), and may also generate a first list including risk analysis results for users 2, 3, and 5 linked to the second service (320) (e.g., a risk analysis result list for accounts based on service 2).

In addition, the account analyzer 121 may store the generated first list in the database 122 and use it for analysis or management of accounts in the future or provide it upon request by the account manager or the like.

Next, in step S120, the computing device 50 such as the account analysis management apparatus 120 executes integrated risk analysis on the first account, among one or more accounts, by considering both the risk analysis results for the first service and the risk analysis results for the second service, among one or more services.

More specifically, referring to FIG. 6, the account analyzer 121 may analyze the risk for the first account of user 1 by considering both the risk analysis results for service 1 (310) and the risk analysis results for service 2 (320).

For example, if the first account of user 1 has accessed service 1 (310) and performed tasks in the past, but has accessed service 2 (320) and performed tasks in the last two months and has no history of accessing service 1 (310), the account analyzer 121 may determine that it is desirable to restrict the access authority of the first account of user 1 for service 1 (310).

More specifically, in step S120, it may be determined whether deletion of the first account or change of authority therefor is necessary.

In addition, in step S120, it may be determined whether creation of a group account for multiple accounts including the first account is necessary.

For example, if it is determined that account 1 of user 1 and account 2 of user 2 access service 2 (320) and perform the same tasks, the account analyzer 121 may determine that it is desirable to create and manage a group account for account 1 of user 1 and account 2 of user 2.

In addition, in a situation where account 1 of user 1 belongs to group account 1 and has access authority for service 1 (310), if the access authority for service 1 (310) is no longer needed due to a change in the tasks of group 1, the account analyzer 121 may determine that it is desirable to restrict the access authority of group account 1 for service 1 (310) or delete personal accounts of the remaining users, excluding the administrator, from group account 1.

Furthermore, in step S120, it is possible to generate a second list including the integrated risk analysis result executed based on multiple risk analysis results for the respective accounts.

As a more specific example, the account analyzer 121 may generate a second list including analysis results of performing integrated risk analysis by considering both the risk analysis result of account 1 of user 1 for service 1 (310) and the risk analysis result thereof for service 2 (320) (e.g., an integrated analysis result list based on account 1 of user 1).

In addition, the account analyzer 121 may store the generated second list in the database 122 to use it for analysis or management of accounts in the future or provide it upon request by the account manager or the like.

In addition, the account analysis management apparatus 120 may perform risk analysis based on machine learning (ML) techniques or the like in step S120, but the disclosure is not necessarily limited thereto.

Next, in step S130, the computing device 50 such as the account analysis management apparatus 120 may suggest whether management is necessary for the first account, based on the results of the integrated risk analysis.

More specifically, the account management proposing unit 123 of the account analysis management apparatus 120, based on the integrated risk analysis result for the first account, may propose to the account manager or user that access authority of the first account be restricted (i.e., presenting an account management recommendation) for a specific service or the first account be deleted from a specific group, so that it may be managed with the minimum authority required for the tasks.

Furthermore, in step S130, it is also possible to propose whether management is necessary for the first account by considering the results of the risk analysis according to step S110 and the integrated risk analysis according to step S120.

As a more specific example, it is possible to provide or propose information whether management is necessary for the account in various ways, such as providing related information when the user accesses a tasks system or generating and sending an email suggesting related content to the account manager.

In this case, the account management proposing unit 123 may perform a function based on a generative artificial intelligence model such as a large language model (LLM) in step S130, but the disclosure is not necessarily limited thereto.

In addition, when executing management such as changing the authority of the account in step S130, it is also possible to perform management such that a passkey system 220 and a key management system (KMS) 230 for user authentication are also changed with a link therewith, and to this end, the account analysis management apparatus 120 may be disposed to be linked with the respective services, the identity and access management (IAM) system 210, the passkey system 220, and the key management system (KMS) 230.

Accordingly, the account analysis management apparatus 120 may perform account usage analysis for each service using machine learning or an artificial intelligence model and request to store the analyzed content in the database 122, and this task may be processed to be continuously performed as a batch work using prompts or the like.

Then, integrated analysis may be performed on the account information analyzed for each service using machine learning or an artificial intelligence model, and the analyzed content may be requested to be stored in the database 122, and this task may be processed to be continuously performed as a batch work using prompts or the like.

In addition, if it is determined that the account needs to be changed as a result of the analysis above, the account management proposing unit 123 may transmit an account change proposal to the account manager and the user of the user account at the time at which the user logs in.

In addition, if the user requests a basis for the change proposal, the account analysis management apparatus 120 may transmit the account analysis content (e.g., role changes due to non-use or department changes) stored in the database 122, and if the user requests additional information analysis content for each service after receiving the account analysis content, the account analysis management apparatus 120 may also provide additional information.

In addition, if the user accepts the account change proposal, it is also possible to propose a method to process the linked identity and access management (IAM) system 210, passkey system 220, and key management system (KMS) 230 at once.

In addition, the account analysis management apparatus 120 may provide an action button or the like while sharing the risks analyzed for the account.

For example, it is possible to propose the removal of an unused account from a specific service, the change of an unused account, or the creation of a new account.

Furthermore, it is possible to analyze a passkey list for the user to identify a linked platform, and to propose blocking support for a platform if the platform is not used for a predetermined period of time or longer.

In addition, it is possible to propose blocking of a user's key if a risk factor is identified as a result of analyzing the key by the key management system (KMS).

Accordingly, the account analysis management apparatus 120 according to an embodiment of the disclosure may manage each account with the minimum authority required in zero trust, and may effectively block security risks such as hacking due to unnecessary authority or key neglect.

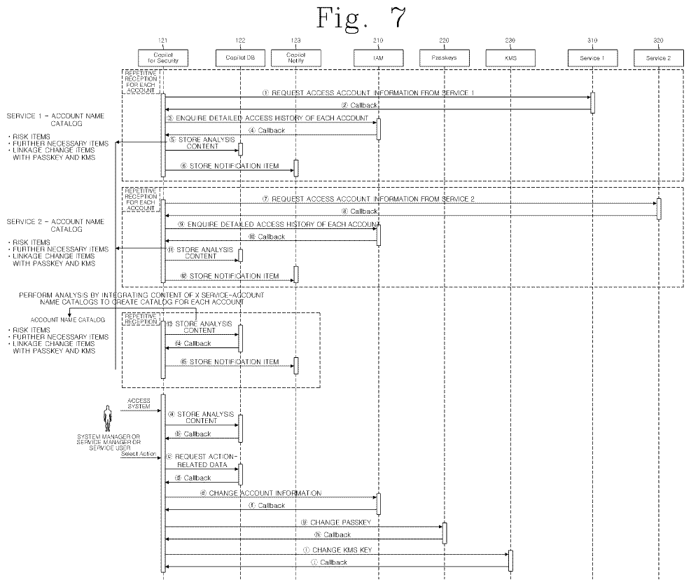

In addition, FIG. 7 illustrates a specific operation of the account analysis management system 100 according to an embodiment of the disclosure.

First, as shown in FIG. 7, the account analyzer 121 may request information about an account having access authority for service 1 (310) (\textcircled{1} in FIG. 7).

In response thereto, service 1 (310) may reply with account information requested (\textcircled{2} in FIG. 7).

Next, the account analyzer 121 may enquire detailed access history of each account, which was replied, of the identity and access management (IAM) system 210 (\textcircled{3} in FIG. 7).

In response thereto, the identity and access management (IAM) system 210 may reply with the requested detailed access history for each account (\textcircled{4} in FIG. 7).

Accordingly, the account analyzer 121 may perform risk analysis on each account linked to the service 1 (310), based on the received information and store it in the database 122 (\textcircled{5} of FIG. 7), and may also provide the account management proposing unit 123 with notification item information to be provided to users, based on the risk analysis results, thereby storing the same (\textcircled{6} of FIG. 7).

In addition, the account analyzer 121 may also request information about the account having access authority for service 2 (320) (\textcircled{7} of FIG. 7).

In response thereto, service 2 (320) may reply with account information requested (\textcircled{8} of FIG. 7).

Next, the account analyzer 121 may enquire detailed access history of each account, which was replied, of the identity and access management (IAM) system 210 (\textcircled{9} of FIG. 7).

In response thereto, the identity and access management (IAM) system 210 may reply with the requested detailed access history for each account (\textcircled{10} in FIG. 7).

Accordingly, the account analyzer 121 may perform risk analysis on each account linked to the service 2 (320) on the basis of the received information and store it in the database 122 (\textcircled{11} in FIG. 7), and may also provide the account management proposing unit 123 with notification item information to be provided to users on the basis of the risk analysis results, thereby storing the same (\textcircled{12} in FIG. 7).

Next, the account analyzer 121 may execute integrated risk analysis on each account by considering both the risk analysis results for the first service and the risk analysis results for the second service, and store the results thereof in the database 122 or provide the stored information (\textcircled{13} and \textcircled{14} in FIG. 7), and may also provide the account management proposing unit 123 with notification item information to be provided to users on the basis of the integrated risk analysis results, thereby storing the same (\textcircled{15} in FIG. 7).

Subsequently, when a user, such as an account manager, accesses the system, the account analyzer 121 may request the analysis content corresponding to the user from the database 122 (\textcircled{a} in FIG. 7) and provide results thereof to the user in return (\textcircled{b} in FIG. 7).

In addition, if the user selects a suggested action button or the like, the account analyzer 121 may request data corresponding to the action button from the database 122 (\textcircled{c} in FIG. 7) and receive data corresponding to the request (\textcircled{d} in FIG. 7).

Subsequently, the account analyzer 121 may request the identity and access management (IAM) system 210 to change account information on the basis of the received data (\textcircled{e} in FIG. 7) and receive the result thereof (\textcircled{f} in FIG. 7).

Furthermore, the account analyzer 121 may also request the linked passkey system 220 and key management system (KMS) 230 to change the account information (\textcircled{g} and \textcircled{i} in FIG. 7) and receive the result thereof (\textcircled{h} and \textcircled{j} in FIG. 7).

Accordingly, the account analysis management system 100 according to an embodiment of the disclosure may perform efficient management through analysis of each account and also perform account management for the linked identity and access management (IAM) system 210, passkey system 220, and key management system (KMS) 230 in batches.

In addition, the computer program according to another aspect of the disclosure is a computer program stored on a computer-readable medium in order to execute a series of steps of the account analysis and management method described above on a computer. The computer program may be a computer program including high-level language code executable in a computer using an interpreter, as well as a computer program including machine language code created by a compiler. In this case, the computer is not limited to a personal computer (PC) or a laptop computer, and includes all types of information processing devices equipped with a central processing unit (CPU) and capable of executing a computer program, such as a server, a smartphone, a tablet PC, a PDA, and a mobile phone.

In addition, the computer-readable medium may be a medium that continuously stores a computer-executable program, or temporarily stores it for execution or download. In addition, the medium may be a variety of recording means or storage means in the form of a single piece of hardware or a combination of multiple pieces of hardware, and may not be limited to a medium directly connected to a computer system, but may also be distributed on a network. Therefore, the above detailed description should not be construed as limiting the disclosure in all respects and should be considered as examples. The scope of the disclosure should be determined by a reasonable interpretation of the appended claims, and all changes within the equivalent scope of the disclosure are included in the scope of the disclosure.

In addition, an apparatus, as the account analysis management apparatus 120 according to an embodiment of the disclosure, may include a processor and a memory and perform analysis on one or more accounts linked to one or more services, and the memory may include instructions configured to cause, when executed by the processor, the apparatus to implement specific operations, and the specific operations may include: performing risk analysis on the respective accounts linked to each of the one or more services; executing integrated risk analysis on a first account, among the one or more accounts, by considering both a risk analysis result for a first service and a risk analysis result for a second service, among the one or more services; and proposing whether management is necessary for the first account on the basis of a result of the integrated risk analysis.

Here, the performing may include: producing each account having access authority for each of the one or more services; producing information about access history for each account; and executing risk analysis on each account according to a predetermined criterion.

In addition, the performing may include analyzing whether there is a risk by identifying whether a predetermined service access period has been exceeded on the basis of the access history of each account.

In addition, the performing may include analyzing whether there is a risk by also considering an access location of each account.

In addition, the performing may include generating a first list including risk analysis results for the respective accounts linked to each of the one or more services.

In addition, the executing may include determining whether deletion of the first account or change of authority thereof is necessary.

In addition, the executing may include determining whether creation of a group account is necessary for a plurality of accounts including the first account.

In addition, the executing may include generating a second list including a result of integrated risk analysis executed based on multiple risk analysis results for the respective accounts.

In addition, the proposing may include proposing whether management is necessary for the first account by considering results of the risk analysis and the integrated risk analysis.

In addition, FIG. 8 illustrates a computing device 50 to which the proposed method of the disclosure may be applied.

Referring to FIG. 8, the computing device 50 may be configured to implement an account analysis management process according to the proposed method of the disclosure.

For example, the computing device 50, to which the proposed method of the disclosure may be applied, may include network devices such as repeaters, hubs, bridges, switches, routers, and gateways, computer devices such as desktop computers and workstations, mobile terminals such as smartphones, portable devices such as laptop computers, home appliances such as digital TVs, and vehicles such as automobiles. As another example, the computing device 50 to which the disclosure may be applied may be included as part of an ASIC (Application Specific Integrated Circuit) implemented in the form of an SoC (System-on-Chip).

The memory 20 may be connected to the processor 10 during operation, and may store programs and/or instructions for processing and controlling the processor 10, and may store data and information used in the disclosure, control information required for processing data and information according to the disclosure, and temporary data generated during the data and information processing process. The memory 20 may be implemented as a storage device such as a ROM (Read-Only Memory), a RAM (Random Access Memory), an EPROM (Erasable Programmable Read-Only Memory), an EEPROM (Electrically Erasable Programmable Read-Only Memory), a flash memory, a SRAM (Static RAM), an HDD (Hard Disk Drive), an SSD (Solid State Drive), and the like.

The processor 10 may be operatively connected to the memory 20 and/or the network interface 30, and may control the operation of respective modules in the computing device 50. In particular, the processor 10 may perform various control functions for performing the proposed method of the disclosure. The processor 10 may also be called a controller, a micro-controller, a micro-processor, a micro-computer, or the like. The proposed method of the disclosure may be implemented by hardware, firmware, software, or a combination thereof. When implementing the disclosure using hardware, an ASIC (application specific integrated circuit) or a DSP (digital signal processor), a DSPD (digital signal processing device), a PLD (programmable logic device), an FPGA (field programmable gate array), or the like, configured to perform the disclosure, may be provided in the processor 10. Meanwhile, when implementing the proposed method of the disclosure using firmware or software, the firmware or software may include instructions related to modules, procedures, or functions that perform functions or operations necessary for implementing the proposed method of the disclosure, and the instructions may be stored in the memory 20 or stored in a computer-readable recording medium (not shown) separate from the memory 20, and may be configured to cause, when executed by the processor 10, the device 50 to perform the proposed method of the disclosure.

In addition, the computing device 50 may include a network interface device 30. The network interface device 30 may be connected to the processor 10 during operation, and the processor 10 may control the network interface device 30 to transmit or receive wireless/wired signals carrying information, data, signals, and/or messages through a wireless/wired network. The network interface device 30 may support various communication standards such as IEEE 802 series, 3GPP LTE (-A), 3GPP 5G, etc., and may transmit and receive control information and/or data signals according to the corresponding communication standards. The network interface device 30 may be implemented outside the computing device 50 as needed.

Accordingly, an account analysis and management method, device, system, and computer program according to an embodiment of the disclosure may analyze accounts for users or user groups to provide the authority required for each account and identify and manage unnecessary accounts or authority, may block security threats by suppressing an attacker from hijacking an account through account management, and may enable integrated management of the linked key management system (KMS) or the like through account analysis.

The electronic devices, computing devices, processors, memories, account analysis management system 100, terminals 110a and 110b, account analysis management apparatus 120, account analyzer 121, database 122, account management proposing unit 123, access management (IAM) system 210, passkey system 220, key management system (KMS) 230, computing device 50, memory 20, and processor 10 described herein and disclosed herein described with respect to FIGS. 1-8 are implemented by or representative of hardware components. As described above, or in addition to the descriptions above, examples of hardware components that may be used to perform the operations described in this application where appropriate include controllers, sensors, generators, drivers, memories, comparators, arithmetic logic units, adders, subtractors, multipliers, dividers, integrators, and any other electronic components configured to perform the operations described in this application. In other examples, one or more of the hardware components that perform the operations described in this application are implemented by computing hardware, for example, by one or more processors or computers. A processor or computer may be implemented by one or more processing elements, such as an array of logic gates, a controller and an arithmetic logic unit, a digital signal processor, a microcomputer, a programmable logic controller, a field-programmable gate array, a programmable logic array, a microprocessor, or any other device or combination of devices that is configured to respond to and execute instructions in a defined manner to achieve a desired result. In one example, a processor or computer includes, or is connected to, one or more memories storing instructions or software that are executed by the processor or computer. Hardware components implemented by a processor or computer may execute instructions or software, such as an operating system (OS) and one or more software applications that run on the OS, to perform the operations described in this application. The hardware components may also access, manipulate, process, create, and store data in response to execution of the instructions or software. For simplicity, the singular term “processor” or “computer” may be used in the description of the examples described in this application, but in other examples multiple processors or computers may be used, or a processor or computer may include multiple processing elements, or multiple types of processing elements, or both. For example, a single hardware component or two or more hardware components may be implemented by a single processor, or two or more processors, or a processor and a controller. One or more hardware components may be implemented by one or more processors, or a processor and a controller, and one or more other hardware components may be implemented by one or more other processors, or another processor and another controller. One or more processors, or a processor and a controller, may implement a single hardware component, or two or more hardware components. As described above, or in addition to the descriptions above, example hardware components may have any one or more of different processing configurations, examples of which include a single processor, independent processors, parallel processors, single-instruction single-data (SISD) multiprocessing, single-instruction multiple-data (SIMD) multiprocessing, multiple-instruction single-data (MISD) multiprocessing, and multiple-instruction multiple-data (MIMD) multiprocessing.

The methods illustrated in FIGS. 1-8 that perform the operations described in this application are performed by computing hardware, for example, by one or more processors or computers, implemented as described above implementing instructions or software to perform the operations described in this application that are performed by the methods. For example, a single operation or two or more operations may be performed by a single processor, or two or more processors, or a processor and a controller. One or more operations may be performed by one or more processors, or a processor and a controller, and one or more other operations may be performed by one or more other processors, or another processor and another controller. One or more processors, or a processor and a controller, may perform a single operation, or two or more operations.

Instructions or software to control computing hardware, for example, one or more processors or computers, to implement the hardware components and perform the methods as described above may be written as computer programs, code segments, instructions or any combination thereof, for individually or collectively instructing or configuring the one or more processors or computers to operate as a machine or special-purpose computer to perform the operations that are performed by the hardware components and the methods as described above. In one example, the instructions or software include machine code that is directly executed by the one or more processors or computers, such as machine code produced by a compiler. In another example, the instructions or software includes higher-level code that is executed by the one or more processors or computer using an interpreter. The instructions or software may be written using any programming language based on the block diagrams and the flow charts illustrated in the drawings and the corresponding descriptions herein, which disclose algorithms for performing the operations that are performed by the hardware components and the methods as described above.

The instructions or software to control computing hardware, for example, one or more processors or computers, to implement the hardware components and perform the methods as described above, and any associated data, data files, and data structures, may be recorded, stored, or fixed in or on one or more non-transitory computer-readable storage media, and thus, not a signal per se. As described above, or in addition to the descriptions above, examples of a non-transitory computer-readable storage medium include one or more of any of read-only memory (ROM), random-access programmable read only memory (PROM), electrically erasable programmable read-only memory (EEPROM), random-access memory (RAM), dynamic random access memory (DRAM), static random access memory (SRAM), flash memory, non-volatile memory, CD-ROMs, CD-Rs, CD+Rs, CD-RWs, CD+RWs, DVD-ROMs, DVD-Rs, DVD+Rs, DVD-RWs, DVD+RWs, DVD-RAMS, BD-ROMs, BD-Rs, BD-R LTHs, BD-REs, blue-ray or optical disk storage, hard disk drive (HDD), solid state drive (SSD), flash memory, a card type memory such as multimedia card micro or a card (for example, secure digital (SD) or extreme digital (XD)), magnetic tapes, floppy disks, magneto-optical data storage devices, optical data storage devices, hard disks, solid-state disks, and/or any other device that is configured to store the instructions or software and any associated data, data files, and data structures in a non-transitory manner and provide the instructions or software and any associated data, data files, and data structures to one or more processors or computers so that the one or more processors or computers can execute the instructions. In one example, the instructions or software and any associated data, data files, and data structures are distributed over network-coupled computer systems so that the instructions and software and any associated data, data files, and data structures are stored, accessed, and executed in a distributed fashion by the one or more processors or computers.

While this disclosure includes specific examples, it will be apparent after an understanding of the disclosure of this application that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents.

Therefore, in addition to the above and all drawing disclosures, the scope of the disclosure is also inclusive of the claims and their equivalents, i.e., all variations within the scope of the claims and their equivalents are to be construed as being included in the disclosure.

What is claimed is:

1. A processor-implemented method, the method comprising:
generating a risk analysis on respective accounts of one or more accounts, the one or more accounts being linked to each service of one or more services;
generating an integrated risk analysis on a first account, among the one or more accounts, by considering both of a first risk analysis result for a first service and a second risk analysis result for a second service, among the one or more services; and
presenting an account management recommendation for the first account responsive to a result of the integrated risk analysis.

2. The method of claim 1, wherein the generating the risk analysis comprises:
identifying each account having access authority for each of the one or more services;
retrieving information about access history for each account; and
executing a risk analysis on each account according to a predetermined criterion.

3. The method of claim 2, wherein the generating the risk analysis further comprises:
determining a presence of a risk by identifying whether a predetermined service access period has been exceeded on a basis of an access history of each account.

4. The method of claim 3, wherein the generating the risk analysis further comprises:
determining the presence of the risk by considering an access location of each account.

5. The method of claim 2, wherein the generating the risk analysis further comprises:
generating a first list, the first list including risk analysis results for the respective accounts linked to each service of the one or more services.

6. The method of claim 1, wherein the generating the integrated risk analysis comprises:
determining whether to perform a deletion of the first account or a change of authority thereof responsive to the result of the integrated risk analysis.

7. The method of claim 1, wherein the generating the integrated risk analysis comprises:
determining whether to create a group account for a plurality of accounts comprising the first account responsive to the result of the integrated risk analysis.

8. The method of claim 1, wherein the generating the integrated risk analysis comprises:
generating a second list, the second list including a result of the integrated risk analysis respectively performed on multiple risk analysis results for the respective accounts.

9. The method of claim 1, wherein the presenting the account management recommendation comprises:
determining whether to perform the account management recommendation for the first account responsive to results of the risk analysis and the integrated risk analysis.

10. An apparatus, the apparatus comprising:
processors configured to execute instructions; and
a memory storing the instructions, wherein execution of the instructions configures the processors to: generate a risk analysis on respective accounts of one or more accounts, the one or more accounts being linked to each service of one or more services;
generate an integrated risk analysis on a first account, among the one or more accounts, by considering both of a first risk analysis result for a first service and a second risk analysis result for a second service, among the one or more services; and
present an account management recommendation for the first account responsive to a result of the integrated risk analysis.

11. The apparatus of claim 10, wherein the generating the risk analysis comprises:
identifying each account having access authority for each of the one or more services;
retrieving information about access history for each account; and
executing a risk analysis on each account according to a predetermined criterion.

12. The apparatus of claim 11, wherein the generating the risk analysis further comprises:
analyzing whether there is a risk by identifying whether a predetermined service access period has been exceeded, based on the access history of each account.

13. The apparatus of claim 12, wherein the generating the risk analysis further comprises:
determining a presence of a risk by identifying whether a predetermined service access period has been exceeded on a basis of an access history of each account.

14. The apparatus of claim 11, wherein the generating the risk analysis further comprises:
generating a first list, the first list including risk analysis results for the respective accounts linked to each service of the one or more services.

15. The apparatus of claim 10, wherein the generating the integrated risk analysis comprises:
determining whether to delete the first account or change an authority thereof responsive to the result of the integrated risk analysis.

16. The apparatus of claim 10, wherein the generating the integrated risk analysis comprises:
determining whether to create a group account for a plurality of accounts comprising the first account responsive to the result of the integrated risk analysis.

17. The apparatus of claim 10, wherein the generating the integrated risk analysis comprises:
generating a second list, the second list comprising a result of integrated risk analysis executed based on multiple risk analysis results for the respective accounts.

18. The apparatus of claim 10, wherein the presenting the account management recommendation comprises:
determining whether to perform the account management recommendation for the first account responsive to results of the risk analysis and the integrated risk analysis.

19. A computer-readable storage medium storing instructions configured to, when executed by a processor, cause an apparatus, comprising the processor and analyzing one or more accounts linked to one or more services, to implement specific operations,
wherein the specific operations comprise:
generating a risk analysis on respective accounts of one or more accounts, the one or more accounts being linked to each service of one or more services;
generating an integrated risk analysis on a first account, among the one or more accounts, by considering both of a first risk analysis result for a first service and a second risk analysis result for a second service, among the one or more services; and
presenting an account management recommendation for the first account responsive to a result of the integrated risk analysis.

20. The computer-readable storage medium of claim 19, wherein the generating the risk analysis comprises:
identifying each account having access authority for each of the one or more services;
retrieving information about access history for each account; and
executing a risk analysis on each account according to a predetermined criterion.
